(19) United States
(12) Patent Application Publication
(10) Pub. No.: US 2014/0198790 A1
(43) Pub. Date: Jul. 17, 2014

(54) DATA LINK LAYER ANALYSIS WITH PACKET TRACE REPLAY

(71) Applicant: INTERNATIONAL BUSINESS MACHINES CORPORATION, (US)

(72) Inventors: David A. Christenson, Fergus Falls, MN (US); Benjamin R. Garbers, Onalaska, WI (US)

(73) Assignee: INTERNATIONAL BUSINESS MACHINES CORPORATION, Armonk, NY (US)

(21) Appl. No.: 13/743,486

(22) Filed: Jan. 17, 2013

(51) Int. Cl. H04L 12/56

(52) U.S. Cl. CPC H04L 45/66
USPC 370/392

(57) ABSTRACT

Systems and methods to analyze layer-2 data frame switch forwarding are provided. A packet replay module may be configured to replay a data frame from at least one of a packet trace file and a live network, and a first switch may include a first port and may be configured to receive the data frame from the packet replay module and to determine a runtime attribute associated with forwarding the data frame in a second switch.

### I. FIELD OF THE DISCLOSURE

The present disclosure relates generally to data communication in a networked computing system, and more particularly, to testing the connectivity and responsiveness associated with data frame forwarding in a computing network.

### II. BACKGROUND

Problems arising in the data link layer (layer-2) of the Open Systems

Interconnection (OSI) model of a network can result in degraded communications. Layer-2 switches use hardware address tables to selectively forward data frames to appropriate destination ports. Verifying that a data frame was forwarded to the appropriate port requires an in depth understanding of Institute of Electrical and Electronics Engineers (IEEE) 802.3 standards. This burden is exponentially increased where large numbers of switching tests must be performed or customized tests are desired. Existing packet trace replay tools can replay a packet trace, but cannot monitor and verify layer-2 protocol operations.

### III. SUMMARY OF THE DISCLOSURE

According to a particular embodiment, an apparatus may include a packet replay module may be configured to replay a data frame from at least one of a packet trace file and a live network. A first switch may include a first port and may be configured to receive the data frame from the packet replay module and to determine a runtime attribute associated with forwarding the data frame in a second switch.

According to another embodiment, a method of analyzing a data frame switch operation may include replaying at a packet replay module a data frame from at least one of a packet trace file and a live network, and receiving at a first switch the data frame from the packet replay module. A runtime attribute associated with forwarding the data frame in a second switch may be determined.

According to another embodiment, a program product may include program code configured to replay a data frame from at least one of a packet trace file and a live network, to receive at a first switch the data frame, and to determine a runtime attribute associated with forwarding the data frame in a second switch. A computer readable medium may bear the program code.

Features and benefits that characterize embodiments are set forth in the claims annexed hereto and foaming a further part hereof. However, for a better understanding of the embodiments, and of the advantages and objectives attained through their use, reference should be made to the Drawings and to the accompanying descriptive matter.

### IV. BRIEF DESCRIPTION OF THE DRAWINGS

FIG. 1 is a block diagram of an embodiment a computing system configured to monitor and analyze data frame switching processes according to an embodiment;

FIG. 2 illustrates an embodiment of a data frame that may be processed by the computing system of FIG. 1;

FIG. 3 is a timing diagram illustrating how a layer-2 switch under test may be configured according to an embodiment;

FIG. 4 is a timing diagram illustrating how an embodiment of a packet trace may be replayed into switch ports owned by a layer-2 switch under test;

FIG. 5 is a timing diagram illustrating a method of initiating implicit source address learning according to an embodiment;

FIG. 6 is a timing diagram illustrating a method link aggregation that may be performed according to an embodiment;

FIG. 7 is a timing diagram illustrating a method of addressing multicast frames using multicast snooper according to an embodiment;

FIG. 8 is a flowchart of an embodiment of a method of verifying that a data frame correctly egresses;

FIG. 9 is a flowchart of a method of configuring a switch of configuring a switch according to an embodiment;

FIGS. 10a and 10b show a flowchart of an embodiment of a method of monitoring and analyzing data frame switching;

FIG. 11 is a flowchart of an embodiment of a method of determining expected egress ports; and

FIG. 12 is a block diagram of a computing apparatus including software and hardware to monitor and verify switch frame delivery in a manner consistent with an embodiment.

### V. DETAILED DESCRIPTION

A packet replay module may provide packets from a packet trace or a live network to a mirror switch configured to analyze layer-2 processes associated with a switch under test. The packet replay module may further modify the packet, or frame, before injecting the frame into a switch port. The mirror switch may inject the frame from the packet replay module into a verification/switch port. A particular embodiment may offload the packet replay protocol knowledge into the mirror switch. The mirror switch may mirror the state of the layer-2 switch under test and may execute the Institute of Electrical and Electronics Engineers (IEEE) 802.3 standard in parallel with the layer-2 switch under test. Both switches may be configured identically or nearly identically, and the ports may be connected. The layer-2 switch under test may be running in a hardware device or a simulator.

An embodiment may simplify IEE 802.3 packet replay writing while providing accurate comprehensive layer-2 forwarding verification. Sequence numbers may be appended to the end of each frame to uniquely identify an egress frame. The embodiment of a system may verify access control list (ACL) functionality, verify a forwarding rate, and recognize aggregated links/ports. The embodiment may further verify that only one frame egresses a trunk, and implements a multicast snooper to learn multicast groups.

Packet replays may be written to inject any Ethernet frame into the layer-2 switch under test to validate compliance. The actual verification may be done by the redundant, layer-2 minor switch and not the packet replay, itself. The mirror switch may verify that the layer-2 switch complies with the IEEE layer-2 forwarding standard. According to another or the same embodiment, packets may be sourced from a real network and replayed in real time into the layer-2 switch. Alternatively or in addition, packets may be replayed from a pre-recorded packet trace file that simulates the packet flows generated by a real customer network.

According to a particular embodiment, the packet replay module may replay packets from a packet trace file or a live network. A ready supply of custom automatically generated test cases may be made available. Layer-2 protocol validation may be provided for all replayed packets, and an embodiment provides random media access control (MAC) address modification. Another embodiment allows ad hoc MAC assignment. Implicit source address (SA) learning may be enabled via implicitly generated gratuitous address resolution protocol (ARP) packets. Another embodiment may provide packet tagging, packet injection rate control, link aggregation verification, and multicast verification.

Functions provided by the packet replay module may include persistent MAC assignment, ad hoc MAC assignment, implicit source address learning, MAC address modification, packet tagging, packet rate control, or any combination thereof. More particularly, persistent MAC assignment may be achieved by mapping the source address to a verification/switch port in a round-robin or random fashion. Source address learning may occur a first time an Ethernet source address is injected into a verification/switch port. Subsequent frames with the same source address may be injected into the same port, unless Ad hoc MAC assignment is requested.

Ad hoc MAC assignment may be achieved by injecting packets in a round robin or random order without considering the source address. Ad hoc MAC assignment may simulate the constant movement of MAC addresses (e.g., VM motion). Implicit source address learning may be performed by internally generating a gratuitous address resolution packet (ARP) packet to simulate source address learning and prevent unicast flooding.

MAC address modification may be performed by converting the destination address, source address, or any combination thereof to a random MAC addresses or sequentially reassigning the destination address, source address, or any combination thereof. Packet tagging may be performed by inserting a virtual local area network (VLAN), a service tag (S-Tag), or any combination thereof into the packet header. Packet rate control may be performed by controlling a rate at which packets are injected. In one example, a constant rate or random (e.g., bursty) rate may be selected.

The minor switch may enable the configuration of ports, trunks, VLANs, and other layer-2 configuration objects. The minor switch may keep track of the switch state so that the minor switch may verify the compliance of the layer-2 switch. The minor switch may inject data frames into a selected verification port. The mirror switch may append a sequence number to the end of each data frame to uniquely identify the data frames as the data frames egress switch ports. The mirror switch may verify that egress data frames are correctly tagged or untagged as specified by the switch configuration. The minor switch may perform multicast snooping to dynamically learn multicast groups and validate compliance. The minor switch may also verify that each injected data frame is forwarded to the appropriate switch port or ports.

The minor switch may be configured to mirror the state of the layer-2 switch under test. The minor switch may go through the same states as the layer-2 switch. Packet replay configures the mirror switch identically to the layer-2 switch. For example, all protocols being tested on the layer-2 switch may also be present on the mirror switch. Based on the current configuration, the mirror switch may calculate what the expected results should be and what the expected egress ports should be. The payloads should be identical, as well. In this manner, the mirror switch may simplify layer-2 analysis by automatically making available expected results for a given configuration.

Embodiments of the switching and analysis system may be realized in hardware, software, or in any combination thereof. In one example, different components, such as the ports, may be distributed. Either or both of the layer-2 switch and the mirror switch may be hardware in one embodiment, and software in another. The terms, “frame” and “packet,” may be used interchangeably throughout this description.

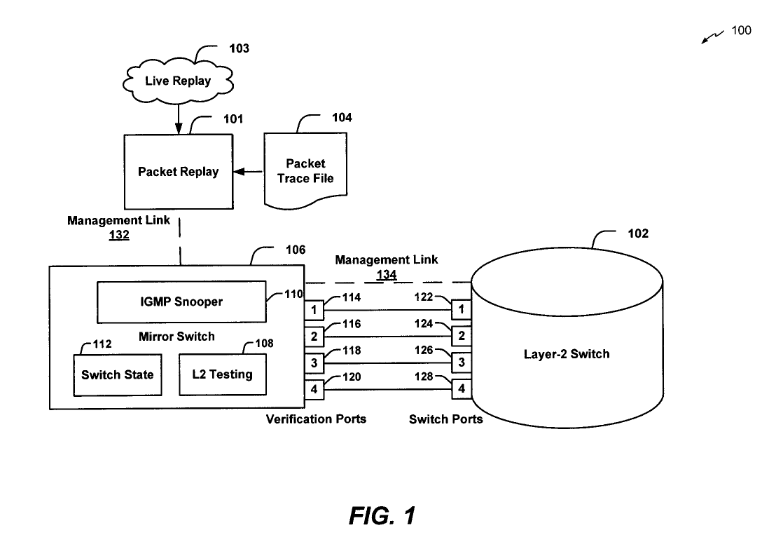

Turning more particularly to the drawings, FIG. 1 shows an embodiment of a computing system 100 configured to monitor and analyze data frames provided by a packet replay module 101. The system 100 may include a layer-2 (L2) switch 102 that receives data (e.g., commands) from the packet replay module 101 forwarded through a minor switch 106, or test switch.

According to a particular embodiment, the packet replay module 101 may replay packets from a packet trace file or a live network. Layer-2 protocol validation may be provided for all replayed packets by the packet replay module 101, and an embodiment provides random MAC address modification. Another embodiment of the packet replay module 101 allows ad hoc MAC assignment. Implicit source address learning may be enabled via implicitly generated gratuitous ARP packets. Another embodiment of the packet replay module 101 may provide packet tagging, packet injection rate control, link aggregation verification, and multicast verification.

The packet replay module 101 may be in communication with the mirror switch 106 via a management link 132. The mirror switch 106 may be identical or nearly identical to the layer-2 switch 102. The layer-2 switch 102 may be the switch under test (SUT). The layer-2 switch 102 may be implemented in hardware or in a simulator, such as Simics.

The mirror switch 106 may generally be configured to emulate and analyze the data frame switching processes of the layer-2 switch 102. The mirror switch 106 may be realized in either hardware or software. The mirror switch 106 may include a layer-2 (L2) testing module 108, an Internet group management protocol (IGMP) snooper module 110, and a switch state 112. The L2 testing module 108 may comprise software or firmware executable to monitor and verify data frame transmission. The IGMP snooper module 110 may be configured to learn multicast groups. The switch state 112 may indicate the state of the layer-2 switch 102. The mirror switch 106 may further include verification ports 114, 116, 118, 120 that are coupled to switch ports 122, 124, 126, 128 of the layer-2 switch 102. A management link 134 may enable configuration commands and related communications between the mirror switch 106 and the layer-2 switch 102.

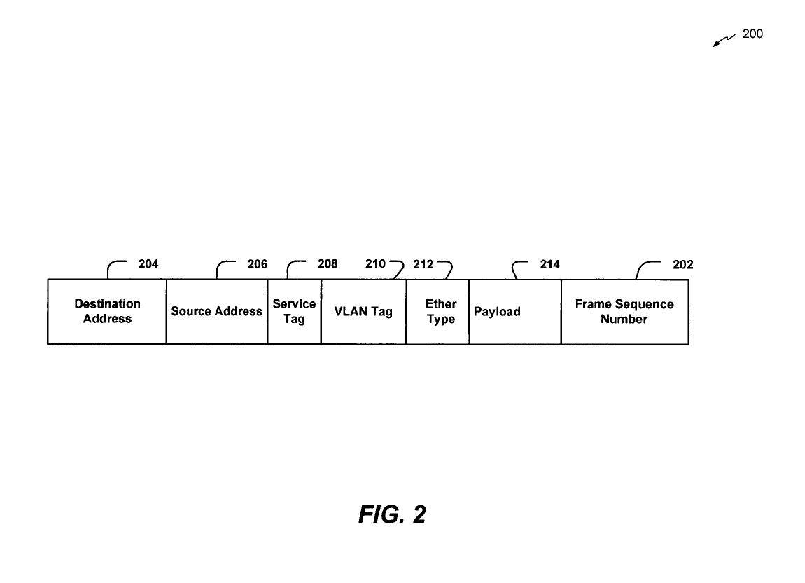

FIG. 2 illustrates an embodiment of a data frame 200. The data frame 200 may be uniquely identified by a sequence number 202. The data frame 200 may additionally include a destination address 204 and a source address 206. A service tag, or S-tag, 208, a virtual local area network (VLAN) tag 210, an Ether Type 212, and a payload 214 may also be included in the illustrative data frame 200.

The sequence number 202 may be appended to the end of each data frame before the data frames are injected into a verification of a mirror switch (and a switch port of a layer-2 switch). The sequence number 202 may be used to uniquely identify the data frame 200. The frame sequence number of another embodiment may include a checksum or any signature used to uniquely identify a data frame and may be appended to the end of the data frame or inserted anywhere in the payload of the data frame. When the data frame 200 egresses a port, the sequence number 202 may be analyzed to see if it is the expected sequence number 202. As discussed herein, other characteristics, such as the payload 214 and the source address 206, may additionally be verified. A properly functioning layer-2 switch may not alter data appended after the payload 214. The frame sequence number 202 may uniquely identify the data frame 200 as the data frame 200 egresses switch ports. The frame sequence number 202 may also be used as a human readable identifier to aid in diagnosing bugs in the layer-2 switch.

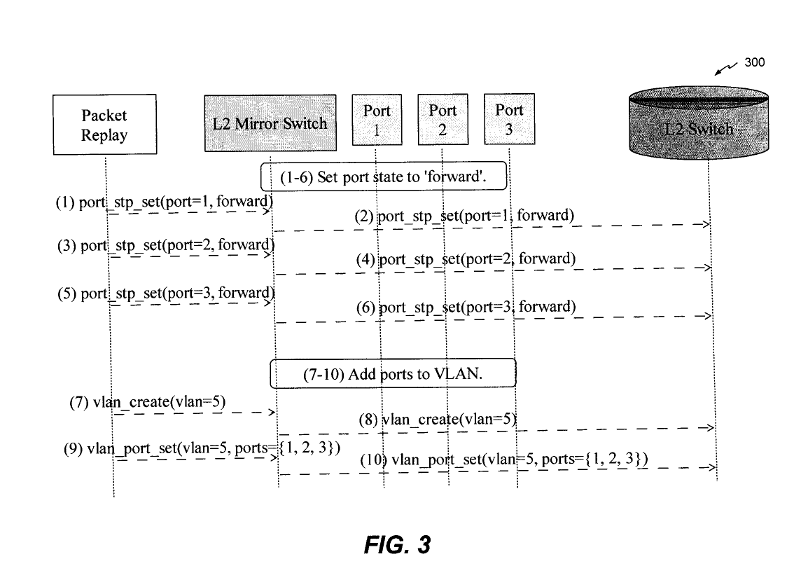

FIG. 3 is a timing diagram 300 illustrating how a layer-2 switch (SUT) may be configured according to an embodiment. The method is illustrated in terms of the interaction between a packet replay module, a mirror switch, ports 1-4, and a layer-2 switch under test. For illustration purposes, the packet replay module 101, the mirror switch 106, the switch ports 1-4 (122, 124, 126, 128), and the layer-2 switch 102 may be similar to those shown in FIG. 1. More particularly, processes 1-6 may set the port state to forward to enable network traffic to flow on the switch ports. One skilled in the art will appreciate that embodiments may be extended to test multiple complex switch configurations. Identical configurations may be stored in both the mirror switch and the layer-2 switch.

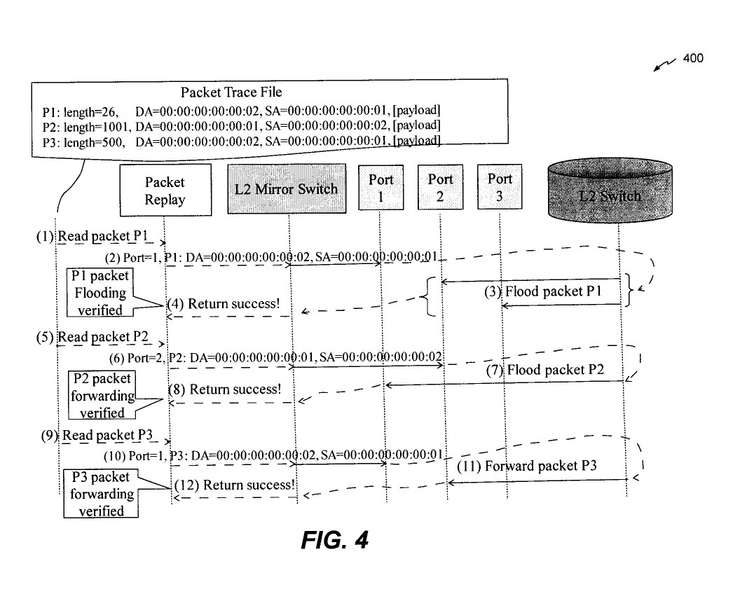

FIG. 4 shows a timing diagram 400 illustrating how an embodiment of a packet trace is replayed into switch ports owned by a layer-2 switch under test. The method is illustrated in terms of the interaction between a packet replay module, a mirror switch, ports 1-4, and a layer-2 switch under test. For illustration purposes, the packet replay module 101, the mirror switch 106, the ports 1-4 (114, 116, 118, 120), and the layer-2 switch 102 may be similar to those shown in FIG. 1. More particularly, processes 1-4 may inject packet P1 into port 1. MAC 00:00:00:00:00:01 may be assigned to port 1, and the packet is injected into port 1. Subsequent packets with source address 00:00:00:00:00:01 may also be injected into port 1, unless an ad hoc MAC assignment is specified. Packet P1 may be flooded, since the destination address 00:00:00:00:00:02 has not yet been learned. The mirror switch may verify that P1 egresses the appropriate ports and returns success to the packet replay module.

Processes 5-8 may inject packet P2 into port 2. MAC 00:00:00:00:00:02 may be assigned to port 2, and the packet may be injected into port 2. Subsequent packets with source address 00:00:00:00:00:02 may also be injected into port 2, unless an ad hoc MAC assignment is specified. Packet P2 may not be flooded, since the destination address 00:00:00:00:00:01 was learned in 2/3. The mirror switch may verify that P2 egresses the appropriate ports and returns success to the packet replay module. Processes 9-12 may inject packet P3 into port 3. Packet P2 may not be flooded, since the destination address 00:00:00:00:00:01 was learned in 2/3. The mirror switch may verify that the P2 egresses the appropriate ports and returns success to the packet replay module.

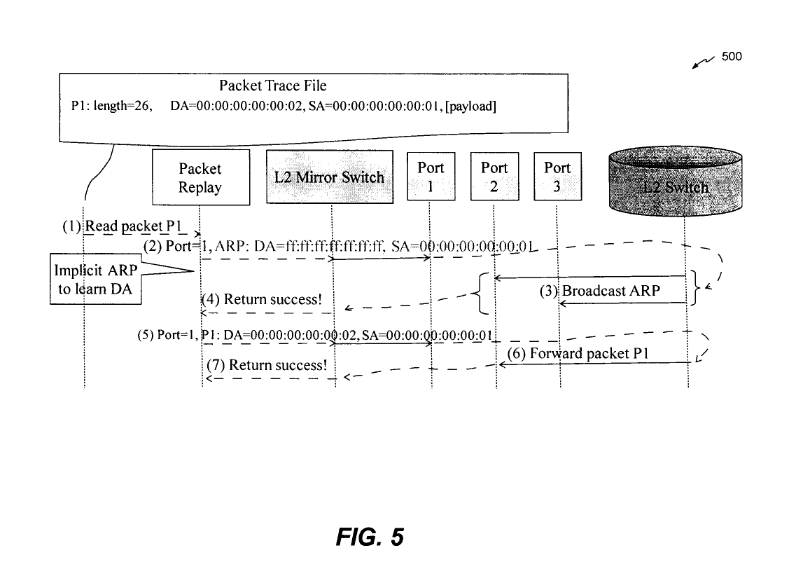

FIG. 5 shows a timing diagram 500 illustrating an embodiment of a method of initiating implicit source address learning. The method is illustrated in terms of the interaction between a packet replay module, a mirror switch, ports 1-4, and a layer-2 switch under test. For illustration purposes, the packet replay module 101, the mirror switch 106, the ports 1-4 (114, 116, 118, 120), and the layer-2 switch 102 may be similar to those shown in FIG. 1. At process 1, the unicast packet P1 may be read. Process 2 of FIG. 5 may inject a gratuitous ARP into port 1 to force port 1 to learn MAC 00:00:00:00:00:01. This may be termed implicit source address learning. The mirror switch may broadcast the ARP to appropriate ports. At process 4, the mirror switch may return success. The unicast packet P1 may be injected into port 1 at process 5. No flooding may be necessary at 6 because the MAC address was learned at process 2. Success may be returned at process 7.

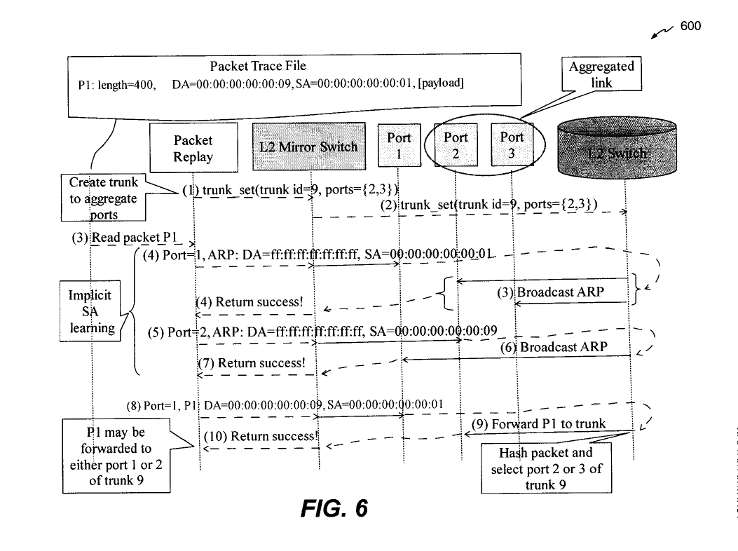

FIG. 6 is a timing diagram 600 illustrating a method of link aggregation that may be performed according to an embodiment. The method is illustrated in terms of the interaction between a packet replay module, a mirror switch, ports 1-4, and a layer-2 switch under test. For illustration purposes, the packet replay module 101, the mirror switch 106, the ports 1-4 (114, 116, 118, 120), and the layer-2 switch 102 may be similar to those shown in FIG. 1.

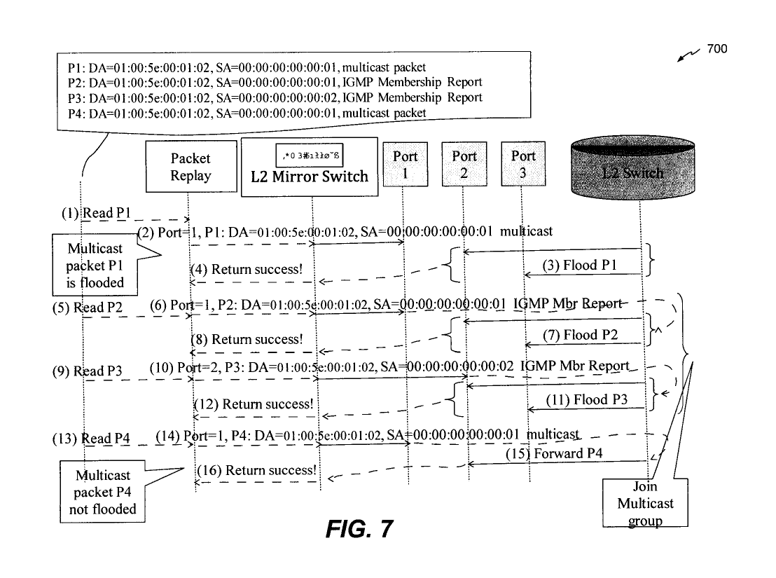

FIG. 7 is a timing diagram 700 illustrating a method of addressing multicast frames using a multicast snooper according to an embodiment. The method is illustrated in terms of the interaction between a packet replay module, a mirror switch, ports 1-4, and a layer-2 switch under test. For illustration purposes, the packet replay module 101, the mirror switch 106, the ports 1-4 (114, 116, 118, 120), and the layer-2 switch 102 may be similar to those shown in FIG. 1.

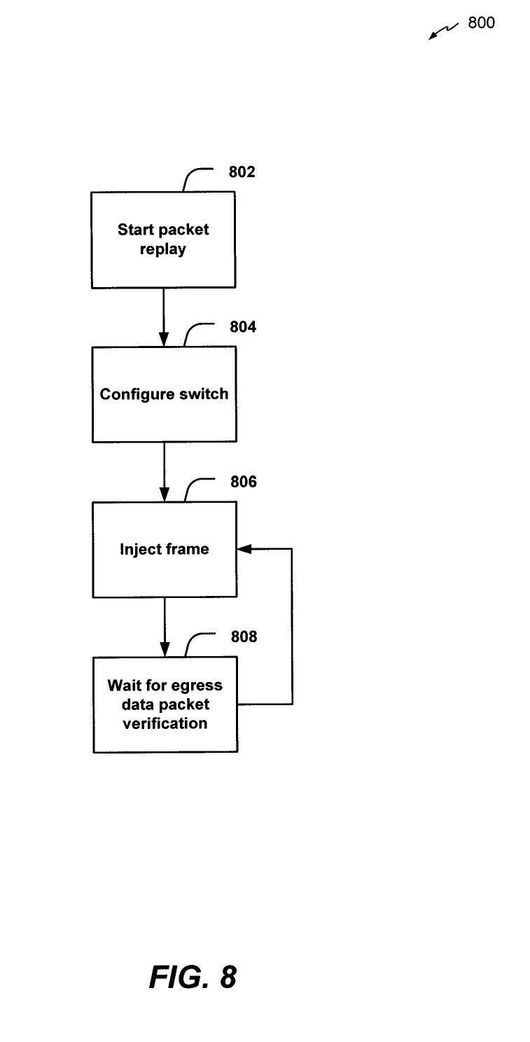

Referring to FIG. 8, a particular embodiment of a method 800 of verifying a runtime attribute, such as a data frame egress, is illustrated. The method 800 includes initiating a packet replay at 802, and the layer-2 switch may be configured at 804. Commands used in the configuration process at 804 are generally shown in FIG. 3.

A data frame may be injected at 806. The processes at 806 may generally relate to those illustrated in FIG. 4. Proceeding to block 808, the method 800 may wait for egress frame verification before returning to block 806. The mirror switch may verify that the data frame egresses the appropriate ports and that the content of the data frame is correct.

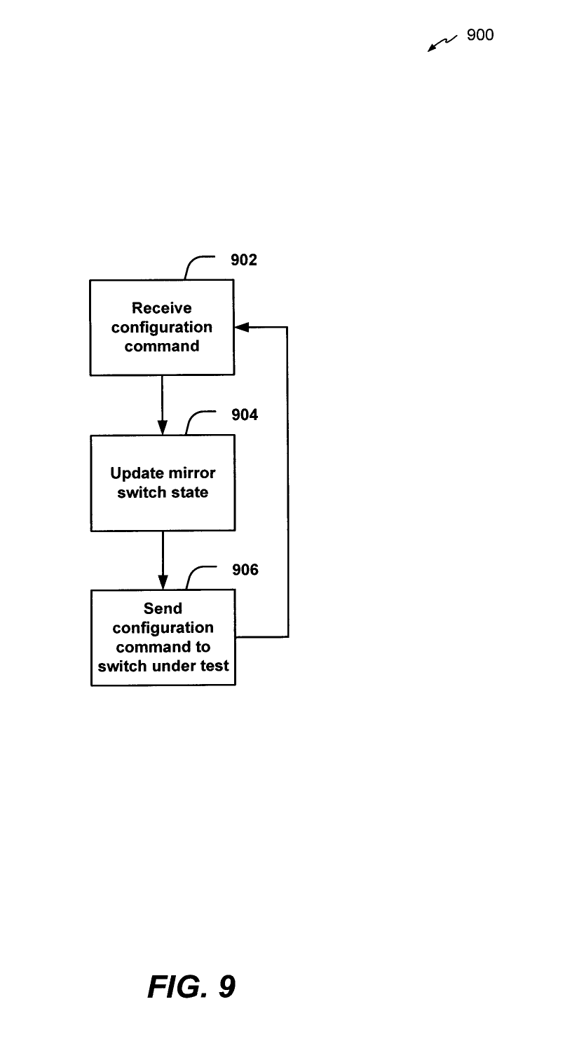

FIG. 9 is a flowchart of an embodiment of a method of configuring a switch, such as the layer-2 switch 106 of FIG. 1. The processes of FIG. 9 may relate generally to the switch configuration processes of FIG. 3 and of 804 of FIG. 8. The method 900 includes receiving a configuration command, at 902. The switch state of the mirror switch may be updated, at 904. The method 900 may send at 906 a configuration command to a switch before returning to 902. Configuration commands may set configuration attributes (e.g., a switch state) of the switch.

Illustrative configuration commands configured to set a state of the switch may include a command that enables or disables the transmission and reception of packets on a physical port. Another command may set the 802.1X authorization status of a port. Commands of other embodiments may set the service tag for a logical port, set port membership for a VLAN, private VLAN, or a trunk (i.e., link aggregation group). Another command may add a static entry to a forwarding cache or may enable port mirroring for a physical port. Still other commands may define an ACL rule to override source address learning, to discard a particular type of packet, or to override VLAN filtering. As such, a state of a switch may be initiated in response to a command affecting switch configuration and forwarding processes.

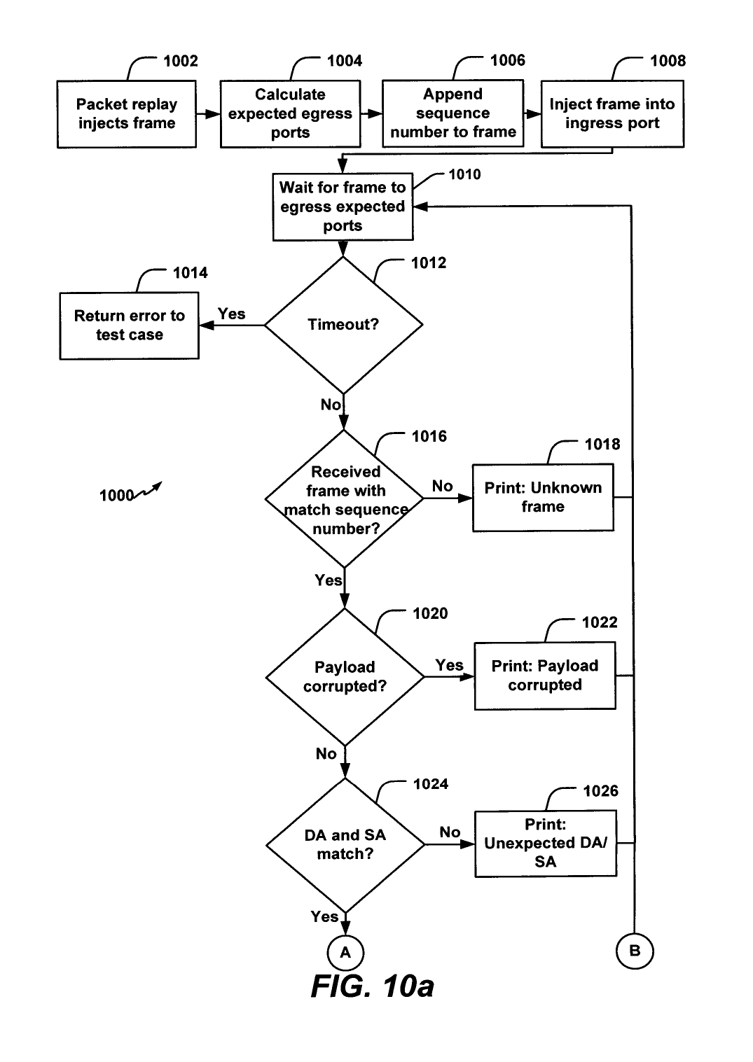

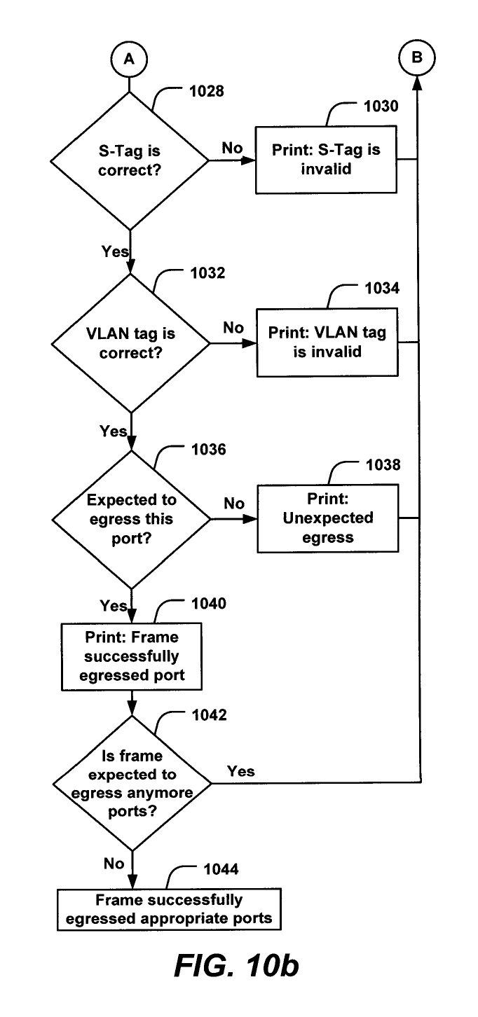

Referring to FIGS. 10a and 10b, a particular embodiment of a method 1000 of monitoring and analyzing data frame switching is illustrated as a flowchart. At 1002 of the flowchart, a data frame may be injected by the packet replay module into the mirror switch.

The method 1000 also includes the mirror switch calculating expected egress ports, at 1004. Determining which ports are expected to egress may be based on the switch configuration, e.g., the state of the switch) and on the type of frame (e.g., a broadcast frame, a multicast frame, a unicast frame, etc.).

Proceeding to block 1006, the mirror switch may append a sequence number to the data frame. The sequence number may be used to uniquely identify the data frame. When the data frame egresses a port, the sequence number may be analyzed to see if it is the expected sequence number. As discussed herein, other characteristics, such as the payload and the source address, may additionally be verified.

At 1008, the mirror switch may inject the data frame into an ingress port. For example, the packet replay module may instruct the mirror switch that the data frame should be injected. Proceeding to block 1010, the method 1000 may wait for the data frame to egress expected ports.

At 1012, the method 1000 determines when a timeout occurs. The timeout may be associated with a computing time expected for the data frame to be successfully forwarded. In an embodiment, a timeout may correspond to a sufficient time for potential frames to arrive for analysis. Where a timeout is detected at block 1012, an error may be returned at 1014. Where no timeout is alternatively detected, the mirror switch may determine at 1016 if a data frame with a matching sequence number has been received. When no data frame with a matching sequence number has been received, the mirror switch may initiate at 1018 an output message indicating an unknown data frame.

Returning to block 1016, where a data frame with a matching sequence number has been received, the mirror switch may determine at 1020 whether a payload is corrupted by comparing the payload to the payload of the originally injected frame. Where the payload is corrupted, the mirror switch may initiate at 1022 an output message indicating that the payload has been corrupted.

Where the payload is determined to be uncorrupted, the mirror switch may determine at 1024 if a destination address (DA) and the source address (SA) match. Where the destination address and the source address do not match, the mirror switch may indicate an error at 1026, and the method 1000 may return to 1010. Where the destination address and the source address match, the mirror switch may determine at 1028 if an S-Tag is correct. Where the S-Tag is not correct, an output indicating that the S-Tag is invalid may be generated at 1030. The S-Tag correctness may be determined using the known switch configuration.

Where the S-Tag is correct, the mirror switch may determine at 1032 whether the VLAN tag is correct. Where the VLAN tag is unexpected, an output indicating that the VLAN tag is invalid may be generated at 1034.

Where the VLAN tag is correct, the mirror switch may determine at 1036 whether a port was expected to be egressed. Where the port was not expected to be egressed, the mirror switch may indicate at 1038 that an unexpected egress has been detected. Where the expected port was egressed, the mirror switch may indicate at 1020 that the data frame has successfully egressed the port.

The mirror switch may determine at 1022 whether the data frame is expected to egress anymore ports. Where the data frame is expected to egress more ports, the method 1000 may return to 1010. Where the data frame is not expected to egress more ports, the data frame has successfully egressed appropriate ports and the method may end at 1024. An output report may be generated for analysis. For example, output files may include linked data that allows a tester to efficiently review highlighted portions of the layer-2 analysis.

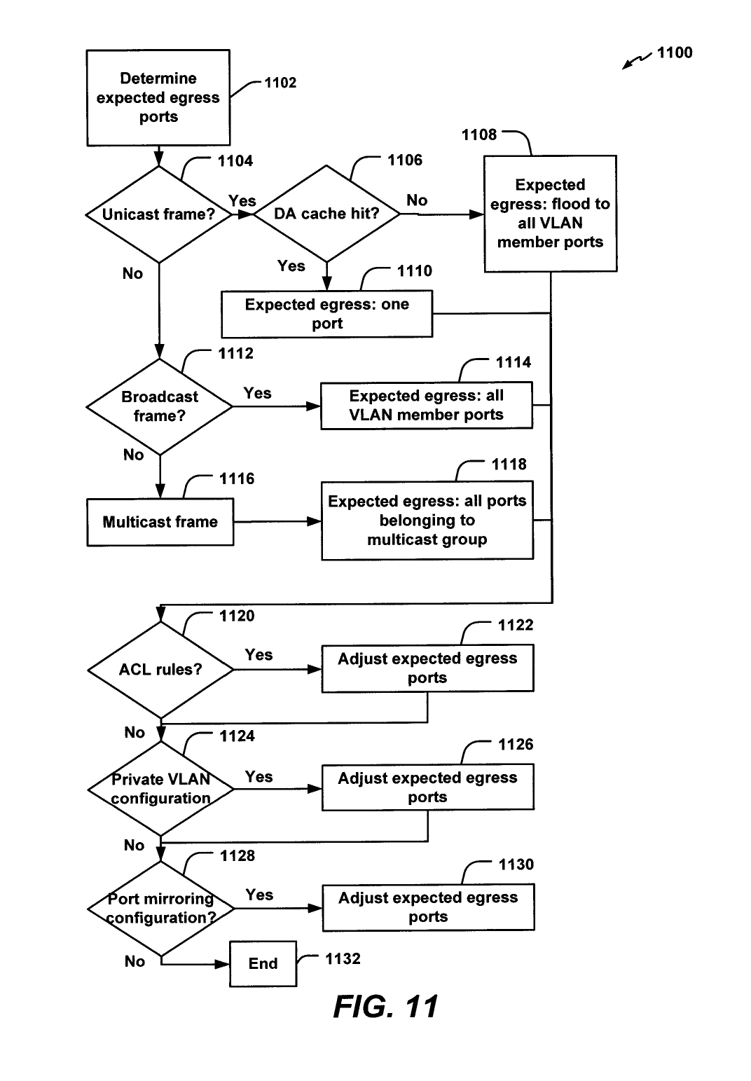

Referring to FIG. 11, a particular embodiment of a method 1100 of determining expected egress ports is illustrated as flowchart. As such, an embodiment of the method 1100 may have application at 1004 of FIG. 10b. The mirror switch may initially determine at 1102 the expected egress ports. The determination may depend in part on the type of data frame.

The mirror switch may determine at 1104 whether a data frame is a unicast data frame. Where the data frame is a unicast data frame, the mirror switch may determine whether a destination cache hit occurs for the destination address of the data frame, at 1106. Where a destination address cache hit occurs, the method 1100 may determine at 1110 that the expected egress is a single port. Where a destination address cache hit alternatively does not occur, the method 1100 may at 1108 determine that the expected egress may be flooding to all VLAN member ports.

Where the data frame is not a unicast data frame, the mirror switch may determine whether the data frame is a broadcast frame, at 1112. When the data frame is a broadcast frame, the expected egress ports at 1114 may be to all VLAN member ports. Where the data frame is a multicast frame at 1116, the expected egress ports may be all ports belonging to a multicast group, at 1118.

At 1120, the method 1100 may determine whether Access Control List (ACL) rules affect the expected egress ports. When the ACL rules effect the expected egress ports, the mirror switch may adjust at 1122 the expected egress ports.

At 1124, the mirror switch may determine whether a private VLAN configuration affects the expected egress ports. A private VLAN may be subset of a VLAN. Where the private VLAN configuration affects the expected egress ports, the mirror switch may at 1126 adjust the expected egress ports according to the private VLAN configuration.

At 1128, the mirror switch may determine whether there is a port mirroring configuration. A port mirroring configuration may cause a frame to be mirrored additional, mirrored ports. Where there is a port mirroring configuration, the mirror switch may adjust at 1130 the expected egress ports to account for the additional mirrored ports. In this manner, the mirror switch of an embodiment may determine expected egress ports in a manner that takes into account the illustrated and other known switch configuration attributes.

One skilled in the art will appreciate that there are many more configuration commands that could affect frame forwarding and that are not illustrated in FIG. 11. For example, an embodiment may determine if VLAN filtering has been enabled. VLAN filtering may discard the frames, if the VLAN tag does not match the VLAN port membership. VLAN filtering may cause the expected egress ports to be adjusted. In another example, having the 802.1x port authorization enabled may also cause the expected egress ports to be adjusted. The 802.1x port authorization may discard the frame, if the port is not currently authorized.

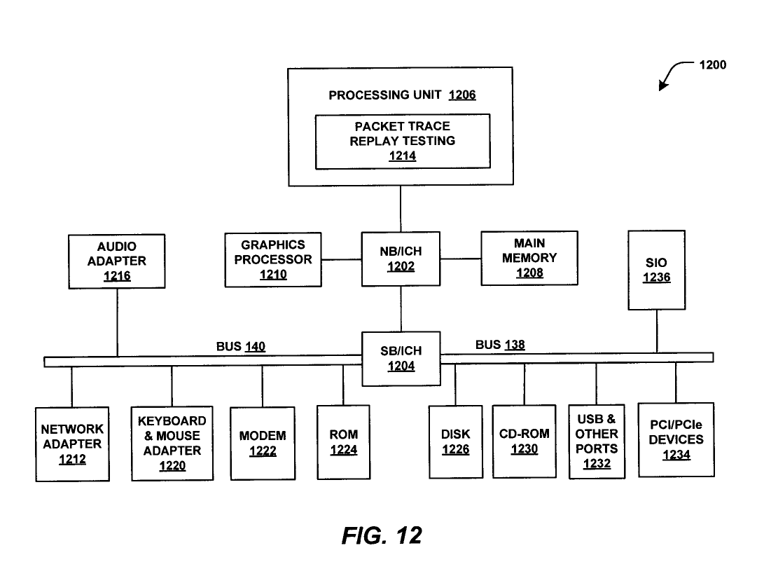

FIG. 12 generally illustrates a block diagram of a computing apparatus 1200 consistent with an embodiment. For example, the apparatus 1200 may include software and hardware to monitor and verify switch frame delivery. The apparatus 1200, in specific embodiments, may include a computer, a computer system, a computing device, a server, a disk array, client computing entity, or other programmable device, such as a multi-user computer, a single-user computer, a handheld device, a networked device (including a computer in a cluster configuration), a mobile phone, a video game console (or other gaming system), etc.

The data processing system may include any device configured to process data and may encompass many different types of device/system architectures, device/system configurations, and combinations of device/system architectures and configurations. Typically, a data processing system will include at least one processor and at least one memory provided in hardware, such as on an integrated circuit chip. However, a data processing system may include many processors, memories, and other hardware and/or software elements provided in the same or different computing devices. Furthermore, a data processing system may include communication connections between computing devices, network infrastructure devices, and the like.

The data processing system 1200 is an example of a single processor unit based system, with the single processor unit comprising one or more on-chip computational cores, or processors. In this example, a processing unit 1206 may constitute a single chip with the other elements being provided by other integrated circuit devices that may be part of a motherboard, multi-layer ceramic package, or the like, to collectively provide a data processing system, computing device or the like. The processing unit 1206 may execute a packet trace replay testing program 1214 to monitor and verify frame switching in accordance with an embodiment.

In the depicted example, the data processing system 1200 employs a hub architecture including a north bridge and a memory controller hub (NB/MCH) 1202, in addition to a south bridge and an input/output (I/O) controller hub (SB/ICH) 1204. A processing unit 1206, a main memory 1208, and a graphics processor 1210 are connected to the NB/MCH 1202. The graphics processor 1210 may be connected to the NB/MCH 1202 through an accelerated graphics port (AGP).

In the depicted example, a local area network (LAN) adapter 1212 connects to the SB/ICH 1204. An audio adapter 1216, a keyboard and mouse adapter 1220, a modem 1222, a read only memory (ROM) 1224, a hard disk drive (HDD) 1226, a CD-ROM drive 1230, a universal serial bus (USB) port and other communication ports 1232, and PCI/PCIe devices 1234 connect to the SB/ICH 1204 through bus 1238 and bus 1240. The PCI/PCIe devices may include, for example, Ethernet adapters, add-in cards, and PC cards for notebook computers. PCI uses a card bus controller, while PCIe does not. ROM 1224 may be, for example, a flash basic input/output system (BIOS).

An HDD 1226 and a CD-ROM drive 1230 connect to the SB/ICH 1204 through the bus 1240. The HDD 1226 and the CD-ROM drive 1230 may use, for example, an integrated drive electronics (IDE) or serial advanced technology attachment (SATA) interface. A duper I/O (SIO) device 1236 may be connected to SB/ICH 1204.

An operating system runs on the processing unit 1206. The operating system coordinates and provides control of various components within the data processing system 1200 in FIG. 12. As a client, the operating system may be a commercially available operating system. An object-oriented programming system programming system may run in conjunction with the operating system and provide calls to the operating system from programs or applications executing on the data processing system 1200. The data processing system 1200 may be a symmetric multiprocessor (SMP) system including a plurality of processors in the processing unit 1206. Alternatively, a single processor system may be employed.

Instructions for the operating system, the object-oriented programming system, and applications or programs are located on storage devices, such as the HDD 1226, and may be loaded into main memory 1208 for execution by processing unit 1206. The processes for illustrative embodiments may be performed by the processing unit 1206 using computer usable program code. The program code may be located in a memory such as, for example, a main memory 1208, a ROM 1224, or in one or more peripheral devices 1226 and 1230, for example.

A bus system, such as the bus 1238 or the bus 1240 as shown in FIG. 12, may be comprised of one or more buses. The bus system may be implemented using any type of communication fabric or architecture that provides for a transfer of data between different components or devices attached to the fabric or architecture. A communication unit, such as the modem 1222 or the network adapter 1212 of FIG. 12, may include one or more devices used to transmit and receive data. A memory may be, for example, the main memory 1208, the ROM 1224, or a cache such as found in the NB/MCH 1202 in FIG. 12.

Those of ordinary skill in the art will appreciate that the embodiments of FIG. 12 may vary depending on the implementation. Other internal hardware or peripheral devices, such as flash memory, equivalent non-volatile memory, or optical disk drives and the like, may be used in addition to or in place of the hardware depicted in FIG. 12. Further, embodiments of the present disclosure, such as the one or more embodiments may take the form of a computer program product accessible from a computer-usable or computer-readable medium providing program code for use by or in connection with a computer or any instruction execution system. For the purposes of this description, a non-transitory computer-usable or computer-readable medium can be any non-transitory medium that can tangibly embody a computer program and that can contain or store the computer program for use by or in connection with the instruction execution system, apparatus, or device.

In various embodiments, the medium can include an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD). The processes of the illustrative embodiments may be applied to a multiprocessor data processing system, such as a SMP, without departing from the spirit and scope of the embodiments.

Moreover, the data processing system 1200 may take the form of any of a number of different data processing systems including client computing devices, server computing devices, a tablet computer, laptop computer, telephone or other communication device, a personal digital assistant (PDA), or the like. In some illustrative examples, the data processing system 1200 may be a portable computing device that is configured with flash memory to provide non-volatile memory for storing operating system files and/or user-generated data, for example. Essentially, the data processing system 1200 may be any known or later developed data processing system without architectural limitation.

Particular embodiments described herein may take the form of an entirely hardware embodiment, an entirely software embodiment or an embodiment containing both hardware and software elements. In a particular embodiment, the disclosed methods are implemented in software that is embedded in processor readable storage medium and executed by a processor, which includes but is not limited to firmware, resident software, microcode, etc.

Further, embodiments of the present disclosure, such as the one or more embodiments may take the form of a computer program product accessible from a computer-usable or computer-readable storage medium providing program code for use by or in connection with a computer or any instruction execution system. For the purposes of this description, a non-transitory computer-usable or computer-readable storage medium may be any apparatus that may tangibly embody a computer program and that may contain, store, communicate, propagate, or transport the program for use by or in connection with the instruction execution system, apparatus, or device.

In various embodiments, the medium may include an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements may include local memory employed during actual execution of the program code, bulk storage, and cache memories that provide temporary storage of at least some program code in order to reduce the number of times code must be retrieved from bulk storage during execution.

Input/output or I/O devices (including but not limited to keyboards, displays, pointing devices, etc.) may be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1. An apparatus comprising:
a packet replay module configured to replay a data frame from at least one of a packet trace file and a live network; and
a first switch including a first port, the first switch is configured to receive the data frame from the packet replay module and to determine a runtime attribute associated with forwarding the data frame in a second switch.

2. The apparatus of claim 1, wherein the packet replay module is further configured to initiate an ad hoc Media Access Control (MAC) address assignment.

3. The apparatus of claim 2, wherein the MAC address assignment includes injecting the data frame without considering the source address.

4. The apparatus of claim 1, wherein the packet replay module is further configured to initiate source address learning.

5. The apparatus of claim 4, wherein the source address learning includes generating an address resolution packet (ARP) packet.

6. The apparatus of claim 1, wherein the packet replay module is further configured to modify a MAC address.

7. The apparatus of claim 1, wherein the packet replay module is further configured to reassign at least one of a source address and a destination address to the data frame.

8. The apparatus of claim 1, wherein the packet replay module is further configured to tag the data frame by adding at least one of a virtual local area network (VLAN) and a service tag (S-Tag).

9. The apparatus of claim 8, wherein the first switch is configured to add a frame sequence number to the data frame.

10. The apparatus of claim 1, wherein the packet replay module is further configured to control a rate at which the data frame is injected.

11. A method of analyzing a data frame switch operation, the method comprising:
replaying at a packet replay module a data frame from at least one of a packet trace file and a live network;
receiving at a first switch the data frame from the packet replay module; and
determining a runtime attribute associated with forwarding the data frame in a second switch.

12. The method of claim 11, further comprising initiating an ad hoc Media Access Control (MAC) address assignment.

13. The method of claim 12, further comprising injecting the data frame without considering the source address.

14. The method of claim 11, further comprising initiating source address learning.

15. The method of claim 14, further comprising generating an address resolution packet (ARP) packet.

16. The method of claim 11, further comprising modifying a MAC address.

17. The method of claim 16, further comprising reassigning at least one of a source address and a destination address to the data frame.

18. The method of claim 11, tagging the data frame by adding a frame sequence number and at least of a virtual local area network (VLAN) and a service tag (S-Tag).

19. The method of claim 11, further comprising controlling a rate at which the data frame is injected.

20. A program product, comprising:
program code configured to replay a data frame from at least one of a packet trace file and a live network, to receive at a first switch the data frame, and to determine a runtime attribute associated with forwarding the data frame in a second switch; and
a computer readable medium bearing the program code.
